(19) United States
(12) Patent Application Publication
(10) Pub. No.: US 2026/0018921 A1
(43) Pub. Date: Jan. 15, 2026

(54) BATTERY CHARGING DEVICE

(71) Applicant: Shindengen Electric Manufacturing Co., Ltd., Tokyo (JP)

(72) Inventors: Makoto TABUTA, Saitama (JP); Syunya TSUKADA, Saitama (JP)

(73) Assignee: Shindengen Electric Manufacturing Co., Ltd., Tokyo (JP)

(21) Appl. No.: 18/998,352

(22) PCT Filed: Jul. 28, 2023
(86) PCT No.: PCT/JP2023/027713

§ 371 Date: Jan. 24, 2025

(30) Foreign Application Priority Data
Jul. 28, 2022 (JP) 2022-120340

(51) Int. Cl. H02J 7/24; H02J 7/02

(52) U.S. Cl. CPC H02J 7/24; H02J 7/02

(57) ABSTRACT

A battery charging device includes: a rectification unit configured to output DC electric power which is obtained by rectifying three-phase AC electric power output from a power generator as charging electric power of a battery through turning-on of a switch element connected to an output signal line of each phase of the three-phase AC electric power with rotation of a rotor; a power supply sustaining switch that is able to be sustained in a state in which control electric power of the switch element from the battery is able to be supplied when a main switch is switched to a cutoff state in which supply of the control electric power to the power supply line is stopped; and a control unit configured to control turning-on of the switch element, the control unit sustaining the power supply sustaining switch in a state in which the control electric power of the switch element is able to be supplied when the main switch is switched to the cutoff state and performing control such that the switch element on a negative electrode side connected to a negative electrode terminal of the battery is switched to a turned-on state when the rotor is rotating.

TECHNICAL FIELD

The present invention relates to a battery charging device. Priority is claimed on Japanese Patent Application No. 2022-120340, filed Jul. 28, 2022, the content of which is incorporated herein by reference.

### BACKGROUND ART

Recently, a battery charging device that is mounted in a vehicle such as a motorcycle has been known (for example, see Patent Document 1). In such a battery charging device according to the related art, three-phase AC electric power output from a power generator is rectified by a full bridge structure using a switch element such as a metal oxide semiconductor field effect transistor (MOSFET) and is converted to DC electric power for charging a battery.

### CITATION LIST

### Patent Document

Patent Document 1: Japanese Unexamined Patent Application, First Publication No. 2012-120293

### SUMMARY OF INVENTION

### Technical Problem

However, in the battery charging device according to the related art, for example, when a main switch is turned off and supply of source electric power (control electric power of a switch element) is stopped while a power generator is rotating (while a vehicle is traveling), control of the switch element is stopped, and thus AC electric power generated by the power generator may be rectified by a parasitic diode of the switch element. In this case, since rectification is performed by the parasitic diode which has a high resistance, there is a likelihood that the switch element may be heated, an abnormality may occur in the device, and the battery may be overcharged.

The present invention was made in order to solve the aforementioned problem, and an objective thereof is to provide a battery charging device that can curb heat which is generated when supply of source electric power is stopped while a power generator is rotating and curb overcharge of a battery.

### Solution to Problem

In order to achieve the aforementioned objective, an aspect of the present invention provides a battery charging device including: a rectification unit configured to output DC electric power which is obtained by rectifying three-phase AC electric power output from a power generator as charging electric power of a battery through turning-on of a switch element connected to an output signal line of each phase of the three-phase AC electric power with rotation of a rotor; a power supply sustaining switch that is able to be sustained in a state in which control electric power of the switch element from the battery is able to be supplied when a main switch for supplying the control electric power of the switch element from the battery to a power supply line is switched to a cutoff state in which supply of the control electric power to the power supply line is stopped; and a control unit configured to control turning-on of the switch element, the control unit sustaining the power supply sustaining switch in a state in which the control electric power of the switch element is able to be supplied when the main switch is switched to the cutoff state and performing control such that the switch element on a negative electrode side connected to a negative electrode terminal of the battery is switched to a turned-on state when the rotor is rotating.

In the battery charging device according to the aspect of the present invention, the switch element may be a metal oxide semiconductor (MOS) transistor, the rectification unit may include a rectification bridge including a positive-electrode MOS transistor connected between a positive-electrode power supply line connected to a positive electrode terminal of the battery and the output signal line and a negative-electrode MOS transistor connected between a negative-electrode power supply line connected to a negative electrode terminal of the battery and the output signal line in each output signal line, and the control unit may perform control such that the negative-electrode MOS transistor of the rectification bridge is switched to a turned-on state when the rotor is rotating.

In the battery charging device according to the aspect of the present invention, the control unit may alternately repeatedly perform a rotation detecting process of switching the positive-electrode MOS transistor and the negative-electrode MOS transistor to a turned-off state and detecting whether the rotor is rotating and a turning-on process of switching the negative-electrode MOS transistor to the turned-on state.

In the battery charging device according to the aspect of the present invention, the control unit may detect whether the rotor is rotating on the basis of a voltage output from the power generator to the output signal line.

The battery charging device according to the aspect of the present invention may further include a rotation detecting unit configured to detect whether the rotor is rotating on the basis of a DC voltage obtained by rectifying the three-phase AC electric power using a diode, and the control unit may detect whether the rotor is rotating on the basis of a detection result from the rotation detecting unit.

In the battery charging device according to the aspect of the present invention, the control unit may switch the power supply sustaining switch to a state in which supply of the control electric power of the switch element is stopped when stop of the rotor is detected.

### Advantageous Effects of Invention

With the battery charging device according to the present invention, control electric power of switch elements of the rectification unit is secured using the power supply sustaining switch when the main switch is switched to a cutoff state, and the negative-electrode switch element is switched to the turned-on state and control is performed such that the output signal line of the power generator has the same potential as the negative-electrode terminal of the battery when the rotor of the power generator is rotating. Accordingly, since the battery charging device can curb rectification using a parasitic diode of the switch element, it is possible to curb heat which is generated when supply of source electric power is stopped while the power generator is rotating and curb overcharge (overvoltage) of the battery.

### BRIEF DESCRIPTION OF DRAWINGS

FIG. 1 A block diagram illustrating an example of a battery charging device according to an embodiment.

FIG. 2A flowchart illustrating an example of operations of the battery charging device according to the embodiment.

FIG. 3 A timing chart illustrating an example of operations of the battery charging device according to the embodiment.

### DESCRIPTION OF EMBODIMENTS

Hereinafter, a battery charging device according to an embodiment of the present invention will be described with reference to the accompanying drawings.

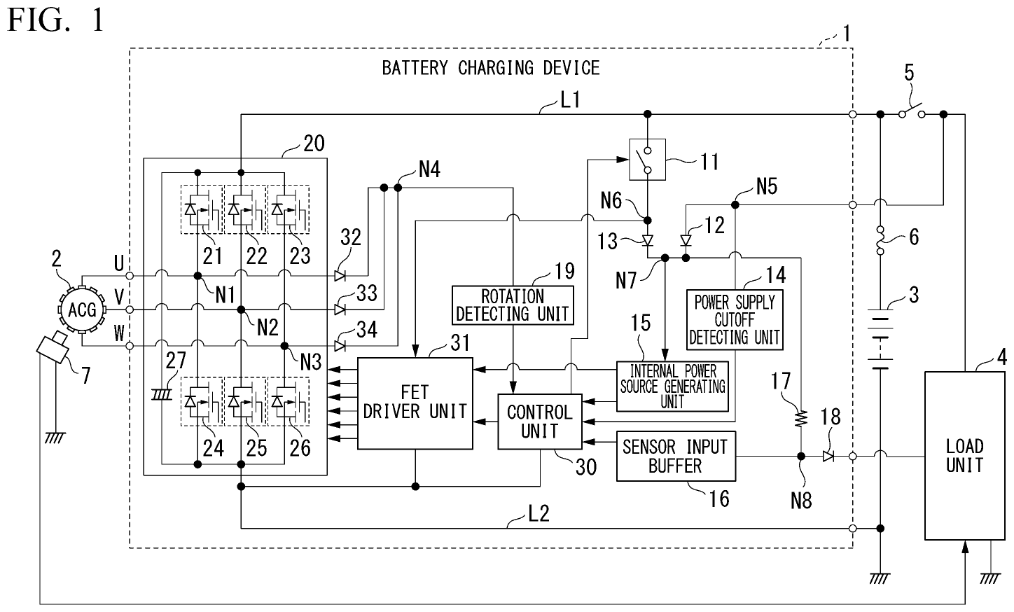

FIG. 1 is a block diagram illustrating an example of a battery charging device 1 according to an embodiment.

As illustrated in FIG. 1, the battery charging device 1 includes a power supply sustaining switch 11, a power supply cutoff detecting unit 14, an internal power source generating unit 15, a sensor input buffer 16, a rotation detecting unit 19, a rectification unit 20, a control unit 30, an FET driver unit 31, diodes (12, 13, 18, and 32 to 34), and a resistor 17.

The battery charging device 1 is also connected to an ACG 2, a battery 3, a load unit 4, a main switch 5, a fuse 6, and a rotational position sensor 7.

The ACG (Alternating Current Generator) 2 is a power generator that generates an AC signal. The ACG 2 outputs AC signals of three phases (a U phase, a V phase, and a W phase) with rotation of a rotor (not illustrated). Here, the rotor is, for example, a crank shaft connected to a rotation shaft of an internal combustion engine (an engine) of a motorcycle.

The battery 3 is, for example, a lead storage battery, where a +(plus) electrode (a positive electrode terminal) is connected to a positive-electrode power supply line L1 via the fuse 6 and a −(minus) electrode (a negative electrode terminal) is connected to a ground terminal (a ground line L2). The battery 3 can be charged with DC electric power which is obtained by causing the rectification unit 20 to rectify the AC signals of three phases (a U phase, a V phase, and a W phase) generated by the ACG 2.

The load unit 4 is, for example, an electrical component of a motorcycle, and examples thereof include an engine control unit (ECU), a fuel pump, an injection, and various sensors. The load unit 4 operates with electric power generated by the ACG 2 or electric power output from the battery 3 supplied via the main switch 5 and consumes electric power.

The main switch 5 is a switch that is provided between the power supply line L1 and a node N5 (a power supply line) and is, for example, a switch for starting a motorcycle. The main switch 5 supplies control electric power of switch elements (21 to 26) from the battery 3 to the power supply line (a node N5 and a node N7).

The fuse 6 is provided between the power supply line L1 and the +electrode of the battery 3 and prevents an overcurrent of a charging current of the battery 3 or an output current of the battery 3.

The rotational position sensor 7 is a sensor that detects a rotational position of the ACG 2. A detection signal from the rotational position sensor 7 is input to the sensor input buffer 16 via the load unit 4 and a diode 18.

The rectification unit 20 outputs DC electric power obtained by rectifying three-phase AC electric power as charging electric power of the battery 3 by turning on the switch elements (21 to 26) connected to output signal lines of three phases of AC electric power output from the ACG 2. The rectification unit 20 includes the switch elements (21 to 26) and a capacitor 27.

The switch elements (21 to 26) are elements for synchronously rectifying three-phases AC signals output from the ACG 2 and are, for example, N-channel metal oxide semiconductor (MOS) transistors and field effect transistors (FETs). The switch elements (21 to 26) include a body diode and are connected between the power supply line L1 and the ground line L2 such that the body diodes are oriented forwardly from the ground line L2 to the power supply line L1.

The switch elements (21 to 23) are positive-electrode MOS transistors connected between the positive-electrode power supply line L1 connected to the positive electrode terminal of the battery 3 and the output signal lines (nodes N1 to N3) with respect to the output signal lines (nodes N1 to N3) of the three-phase AC signals.

The switch elements (24 to 26) are negative-electrode MOS transistors connected between the negative-electrode power supply line (the ground line L2) connected to the negative electrode terminal of the battery 3 and the output signal lines (nodes N1 to N3).

The positive-electrode MOS transistors (switch elements (21 to 23)) and the negative-electrode MOS transistors (switch elements (24 to 26)) constitute a rectification bridge. That is, the rectification unit 20 includes a rectification bridge including the positive-electrode MOS transistors (switch elements (21 to 23)) and the negative-electrode MOS transistors (switch elements (24 to 26)).

In the rectification unit 20, the switch element 21 and the switch element 24 are connected in series between the power supply line L1 and the ground line L2 via the node N1, and the switch element 22 and the switch element 25 are connected in series between the power supply line L1 and the ground line L2 via the node N2. The switch element 23 and the switch element 25 are connected in series between the power supply line L1 and the ground line L2 via the node N3.

The capacitor 27 is provided between the positive-electrode power supply line L1 and the ground line L2 and smooths a DC voltage rectified by the rectification bridge of the rectification unit 20.

The power supply sustaining switch 11 is a switch that can be sustained in a state in which control electric power of the switch elements (21 to 26) from the battery 3 is able to be supplied when the main switch 5 is in the cutoff state in which supply of the control electric power to the power supply line (the node N5 and the node N7) is stopped. Turning-on of the power supply sustaining switch 11 is controlled on the basis of a control signal from the control unit 30 which will be described later. The power supply sustaining switch 11 is switched to a state in which supply of the control electric power is stopped when it is in an OFF state (a turned-off state). The power supply sustaining switch 11 is switched to a state in which the control electric power is able to be supplied when it is in an ON state (a turned-on state).

The power supply cutoff detecting unit 14 detects that the main switch 5 is switched to the OFF state and supply of the control electric power to the node N5 is stopped on the basis of the voltage of the node N5. The power supply cutoff detecting unit 14 outputs a detection result to the control unit 30.

An anode terminal of the diode 12 is connected to the node N5, a cathode terminal thereof is connected to the node N7, and the diode 12 prevents the control electric power supplied via the power supply sustaining switch 11 from flowing back to the node N5.

An anode terminal of the diode 12 is connected to the node N6, a cathode terminal thereof is connected to the node N7, and the diode 12 prevents the control electric power supplied via the main switch 5 from flowing back to the node N6.

The internal power source generating unit 15 generates a control voltage for driving the switch elements (21 to 26) of the rectification unit 20 and operating the control unit 30 from output electric power of the battery 3 supplied to the node N7 or electric power rectified by the rectification unit 20. The control voltage generated by the internal power source generating unit 15 is supplied to the control unit 30 and is also supplied to the FET driver unit 31.

The sensor input buffer 16 receives a detection signal from the rotational position sensor 7 via the load unit 4 and the diode 18 and converts the received detection signal to a voltage which can be received by the control unit 30. The sensor input buffer 16 supplies a signal indicating a rotational position of the ACG 2 to the control unit 30.

The resistor 17 is a pull-up resistor that is provided between the node N7 and the node N8.

An anode terminal of the diode 18 is connected to the node N8, and a cathode terminal thereof is connected to the detection signal of the rotational position sensor 7 via the load unit 4. The diode 18 prevents the detection signal of the rotational position sensor 7 from flowing back to the node N8 via the load unit 4.

The rotation detecting unit 19 detects whether the rotor is rotating on the basis of a DC voltage (the voltage of the node N4) which is obtained by rectifying three-phase

AC electric power using the diodes (32 to 34). For example, when the voltage of the node N4 is higher than the output voltage of the battery 3, the rotation detecting unit 19 determines that the rotor is rotating. The rotation detecting unit 19 supplies a detection signal indicating whether the rotor is rotating to the control unit 30.

An anode terminal of the diode 32 is connected to the node N1, a cathode terminal thereof is connected to the node N4, and the diode 32 outputs a DC voltage obtained by rectifying an AC signal of the U phase using a system separate from the rectification unit 20.

An anode terminal of the diode 33 is connected to the node N2, a cathode terminal thereof is connected to the node N4, and the diode 33 outputs a DC voltage obtained by rectifying an AC signal of the V phase using a system separate from the rectification unit 20.

An anode terminal of the diode 34 is connected to the node N3, a cathode terminal thereof is connected to the node N4, and the diode 34 outputs a DC voltage obtained by rectifying an AC signal of the W phase using a system separate from the rectification unit 20.

The FET driver unit 31 converts a control signal output from the control unit 30 to a drive signal of the switch elements (21 to 26). The FET driver unit 31 generates the drive signal of the switch elements (21 to 26) using the control voltage generated by the internal power source generating unit 15.

The control unit 30 is, for example, a processor including a central processing unit (CPU) and comprehensively controls the battery charging device 1. When the main switch 5 is in the ON state, the control unit 30 controls the switch elements (21 to 26) such that synchronous rectification is performed by the rectification unit 20 and the battery 3 is appropriately charged on the basis of the rotational position information detected by the rotational position sensor 7. The control unit 30 outputs a control signal for controlling turning-on of the switch elements (21 to 26) via the FET driver unit 31.

The control unit 30 sustains the power supply sustaining switch 11 in a state in which control electric power is able to be supplied to the switch elements (21 to 26) when the main switch 5 is switched to the cutoff state and switches the negative-electrode switch elements (24 to 26) connected to the negative electrode terminal of the battery 3 to the ON state (the turned-on state) when the rotor is rotating. That is, the control unit 30 switches the negative-electrode MOS transistors (the switch elements (24 to 26)) in the rectification bridge of the rectification unit 20 to the ON state when the main switch 5 is in the cutoff state and the rotor is rotating.

The control unit 30 detects that the main switch 5 is switched to the cutoff state (the OFF state) using the power supply cutoff detecting unit 14. When it is detected that the main switch 5 is switched to the cutoff state (the OFF state) using the power supply cutoff detecting unit 14, the control unit 30 performs control for sustaining the power supply sustaining switch 11 in the ON state.

The control unit 30 alternately repeatedly performs a rotation detecting process of switching the positive-electrode switch elements (21 to 23) and the negative-electrode switch elements (24 to 26) to the OFF state (the turned-off state) and detecting whether the rotor is rotating and a turning-on process of switching the negative-electrode switch elements (24 to 26) to the ON state in a predetermined period.

The control unit 30 detects whether the rotor is rotating on the basis of a voltage which is output from the ACG 2 to the output signal lines (the node N1, the node N2, and the node N3). Specifically, the control unit 30 detects whether the rotor is rotating on the basis of the detection result from the rotation detecting unit 19.

When stop of the rotor is detected, the control unit 30 switches the power supply sustaining switch 11 to a state in which supply of the control electric power of the switch elements (21 to 26) is stopped. That is, when it is detected that rotation of the rotor is stopped using the rotation detecting unit 19, the control unit 30 performs control for switching the power supply sustaining switch 11 to the OFF state.

Operations of the battery charging device 1 according to the present embodiment will be described below with reference to the drawings.

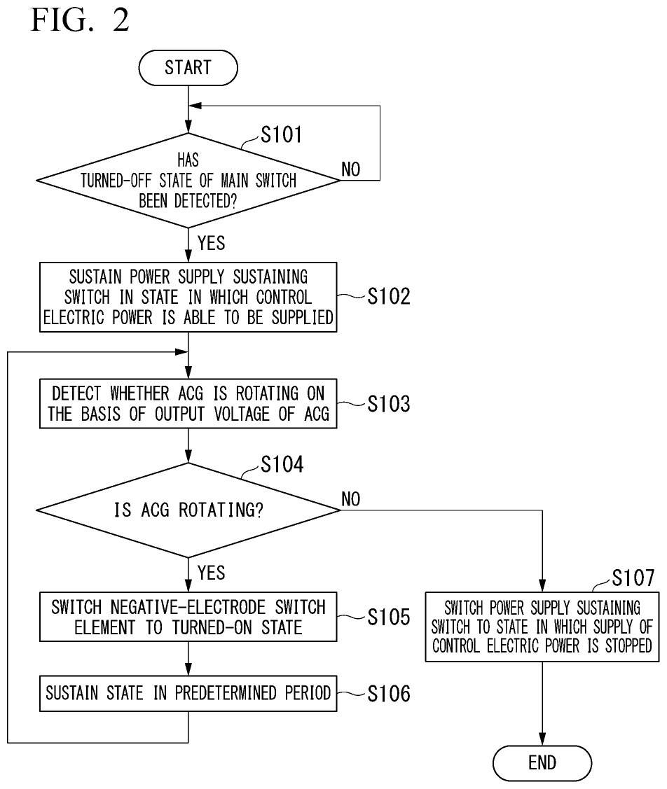

FIG. 2 is a flowchart illustrating an example of operations of the battery charging device 1 according to the present embodiment. In FIG. 2, operations when the main switch 5 is switched from the ON state (state in which control electric power is supplied) to the OFF state (cutoff state) are illustrated.

As illustrated in FIG. 2, first, the battery charging device 1 determines whether the OFF state of the main switch 5 has been detected (Step S101). The control unit 30 of the battery charging device 1 determines whether the OFF state of the main switch 5 has been detected on the basis of the output of the power supply cutoff detecting unit 14. The power supply cutoff detecting unit 14 detects that the main switch 5 is in the OFF state when the voltage of the node N5 is equal to or less than a threshold voltage. When the OFF state of the main switch 5 has been detected (Step S101: YES), the control unit 30 causes the process flow to proceed to Step S102. When the ON state of the main switch 5 has been detected (Step S101: NO), the control unit 30 returns the process flow to Step S101.

In Step S102, the control unit 30 sustains the power supply sustaining switch 11 in the state in which the control electric power is able to be supplied. That is, the control unit 30 performs control for switching the power supply sustaining switch 11 to the ON state. Accordingly, the source voltage of the power supply line L1 is supplied to the internal power source generating unit 15 via the power supply sustaining switch 11 and the diode 13, and operating power sources of the control unit 30 and the FET driver unit 31 are secured.

Then, the control unit 30 detects whether the ACG 2 is rotating on the basis of the output voltage of the ACG 2 (Step S103). The control unit 30 first performs control for switching the positive-electrode switch elements (21 to 23) and the negative-electrode switch elements (24 to 26) to the OFF state and the rotation detecting unit 19 detects whether the ACG 2 is rotating on the basis of the voltage of the node N4 which is obtained by rectifying three-phase AC signals using the diodes (32 to 34). The control unit 30 detects whether the ACG 2 is rotating on the basis of the detection result from the rotation detecting unit 19.

Then, the control unit 30 determines whether the ACG 2 (the rotor) is rotating (Step S104). When the ACG 2 (the rotor) is rotating (Step S104: YES), the control unit 30 causes the process flow to proceed to Step S105. When the ACG 2 (the rotor) is not rotating (Step S104: NO), the control unit 30 causes the process flow to proceed to Step S107.

In Step S105, the control unit 30 switches the negative-electrode switch elements (24 to 26) to the ON state. The control unit 30 outputs a control signal for switching the negative-electrode switch elements (24 to 26) to the ON state via the FET driver unit 31.

Then, the control unit 30 sustains the state in a predetermined period (Step S106). The predetermined period corresponds to a cooling period in which the negative-electrode switch elements (24 to 26) are switched to the ON state, a large current can thus flow, and heating of the negative-electrode switch elements (24 to 26) is curved. After the process of Step S106, the control unit 30 returns the process flow to Step S103.

In Step S107, the control unit 30 switches the power supply sustaining switch 11 to the state in which supply of the control electric power is stopped. That is, when rotation of the ACG 2 (the rotor) is stopped, the control unit 30 performs control for switching the power supply sustaining switch 11 to the OFF state. After the process of Step S107, the control unit 30 ends the process flow.

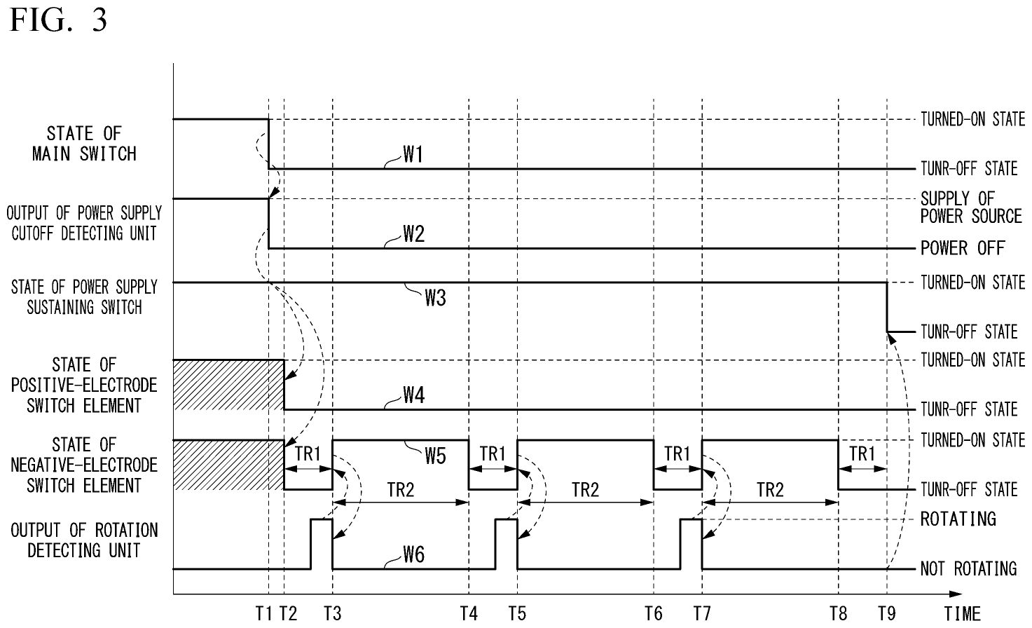

FIG. 3 is a timing chart illustrating an example of operations of the battery charging device 1 according to the present embodiment.

In FIG. 3, waveforms indicate a state (a waveform W1) of the main switch 5, an output (a waveform W2) of the power supply cutoff detecting unit 14, a state (a waveform W3) of the power supply sustaining switch 11, a state (a waveform W4) of the positive-electrode switch elements (21 to 23), a state (a waveform W5) of the negative-electrode switch elements (24 to 26), and an output (a waveform W6) of the rotation detecting unit 19. The horizontal axis of the waveforms represent time.

As illustrated in FIG. 3, when the main switch 5 is switched from the ON state to the OFF state at time Tl (see the waveform W1), the output of the power supply cutoff detecting unit 14 changes from the power supply state to the power supply cutoff state (see the waveform W2). Even when it is detected that the output of the power supply cutoff detecting unit 14 changes to the power supply cutoff state, the control unit 30 sustains the ON state of the power supply sustaining switch 11 (see the waveform W3). Accordingly, the source voltage of the power supply line L1 is supplied to the internal power source generating unit 15, and the operating power sources of the control unit 30 and the FET driver unit 31 are secured.

In FIG. 3, the hatched period of the positive-electrode switch elements (21 to 23) and the negative-electrode switch elements (24 to 26) indicates a phase-controlled state. In FIG. 3, it is assumed that both the initial states of the main switch 5 and the power supply sustaining switch 11 are the ON state.

Then, at time T2, the control unit 30 switches the positive-electrode switch elements (21 to 23) and the negative-electrode switch elements (24 to 26) to the OFF state (see the waveform W4 and the waveform W5) in order to detect the rotation of the ACG 2. Then, the control unit 30 acquires the output of the rotation detecting unit 19 and switches the negative-electrode switch elements (24 to 26) to the ON state (see the waveform W5 and the waveform W6) while sustaining the power supply sustaining switch 11 in the ON state (see the waveform W3) at time T3 because the ACG 2 is rotating.

The control unit 30 sustains this state in a predetermined period (a period TR2). At time T4, the control unit 30 switches the positive-electrode switch elements (21 to 23) and the negative-electrode switch elements (24 to 26) to the OFF state again (see the waveform W4 and the waveform W5) in order to detect the rotation of the ACG 2.

Then, at time T5, the control unit 30 acquires the output of the rotation detecting unit 19 and switches the negative-electrode switch elements (24 to 26) to the ON state again (see the waveform W5 and the waveform W6) because the ACG 2 is rotating. The processes at time T6 and at time T7 are the same as processes at time T4 and at time T5.

At time T8, the control unit 30 switches the positive-electrode switch elements (21 to 23) and the negative-electrode switch elements (24 to 26) to the OFF state again (see the waveform W4 and the waveform W5) in order to detect the rotation of the ACG 2. Then, at time T9, the control unit 30 acquires the output of the rotation detecting unit 19 and switches the power supply sustaining switch 11 to the OFF state again (see the waveform W3) because the ACG 2 is not rotating.

In FIG. 3, the periods TRI between time T2 and time T3, between time T4 and time T5, between time T6 and time T7, and between time T8 and time T9 are periods for the rotation detecting process. The periods TR2 between time T3 and time T4, between time T5 and time T6, and between time T7 and time T8 are periods for the turning-on process and correspond to the cooling period of the rectification unit 20.

In the present embodiment, the period TR 1 for the rotation detecting process is set such that the rotation of the ACG 2 (the rotor) can be stably detected without depending on the rotation speed of the ACG 2. The period TR2 for the turning-on process (the predetermined period) is set such that heating is appropriately curbed in comparison with the period TR1.

As described above, the battery charging device 1 according to the present embodiment includes the rectification unit 20, the power supply sustaining switch 11, and the control unit 30. The rectification unit 20 outputs DC electric power obtained by rectifying three-phase AC electric power as charging electric power of the battery 3 by turning on the switch elements (21 to 26) connected to the output signal lines (nodes N1 to N3) of three phases of the AC electric power output from the ACG 2 (the power generator) with rotation of the rotor. When the main switch 5 for supplying the control electric power of the switch elements (21 to 26) from the battery 3 to the power supply line (the power supply line L1) is in the cutoff state in which supply of the control electric power to the power supply line is stopped, the power supply sustaining switch 11 can be sustained in the state in which the control electric power of the switch elements (21 to 26) from the battery 3 is able to be supplied. The control unit 30 controls turning-on of the switch elements (21 to 26). The control unit 30 sustains the power supply sustaining switch 11 to the state in which the control electric power of the switch elements (21 to 26) is able to be supplied when the main switch 5 is switched to the cutoff state and switches the negative-electrode switch elements (24 to 26) connected to the negative electrode terminal (the ground line L2) of the battery 3 to the turned-on state when the rotor is rotating.

Accordingly, the battery charging device 1 according to the present embodiment secures the control electric power of the switch elements (21 to 26) of the rectification unit 20 using the power supply sustaining switch 11 when the main switch 5 is switched to the cutoff state, and switches the negative-electrode switch elements (24 to 26) to the ON state and controls the output signal lines of the ACG 2 at the same potential as that of the negative electrode terminal (the ground line L2) of the battery 3 when the rotor of the ACG 2 is rotating. Accordingly, since the battery charging device 1 according to the present embodiment can curb rectification using the parasitic diodes (body diodes) of the switch elements (21 to 26), it is possible to curb heating which is caused when supply of source electric power is stopped while the ACG 2 is rotating and to curb overcharging (an overvoltage) of the battery 3.

In the present embodiment, the switch elements (21 to 26) are MOS transistors. The rectification unit 20 includes a rectification bridge. The rectification bridge includes the positive-electrode MOS transistors (the switch elements (21 to 23)) connected between the positive-electrode power supply line L1 connected to the positive electrode terminal of the battery 3 and the output signal lines and the negative-electrode

MOS transistors (the switch elements (24 to 26)) connected between the negative-electrode power supply line (the ground line L2) connected to the negative electrode terminal of the battery 3 and the output signal lines in the output signal lines (the node N1, the node N2, and the node N3). The control unit 30 switches the negative-electrode MOS transistors (the switch elements (24 to 26)) in the rectification bridge to the ON state when the rotor is rotating.

Accordingly, with the battery charging device 1 according to the present embodiment, since the rectification bridge is provided, it is possible to efficiently perform rectification and to simply curb heating by switching the negative-electrode

MOS transistors (the switch elements (24 to 26)) in the rectification bridge to the ON state.

In the present embodiment, the control unit 30 alternately repeatedly performs the rotation detecting process of switching the positive-electrode MOS transistors (the switch elements (21 to 23)) and the negative-electrode MOS transistors (the switch elements (24 to 26)) to the OFF state (the turned-off state) and detecting whether the rotor is rotating (the process in the period TR1) and the turning-on process of switching the negative-electrode MOS transistors (the switch elements (24 to 26)) to the ON state (the process in the period TR2) in a predetermined period.

Accordingly, with the battery charging device 1 according to the present embodiment, it is possible to accurately detect the rotation of the rotor and to appropriately curb heating due to the parasitic didoes (body diodes) of the switch elements (21 to 26) by alternately repeatedly performing the rotation detecting process (the process in the period TR1) and the turning-on process (the process in the period TR2).

In the present embodiment, the control unit 30 detects whether the rotor is rotating on the basis of the voltage which is output from the ACG 2 to the output signal lines (the node N1, the node N2, and the node N3).

Accordingly, with the battery charging device 1 according to the present embodiment, since the voltage output from the ACG 2 to the output signal lines (the node N1, the node N2, and the node N3) is used, it is possible to appropriately detect whether the rotor is rotating with a simple configuration.

The battery charging device 1 according to the present embodiment includes the rotation detecting unit 19 that detects whether the rotor is rotating on the basis of the DC voltage (the voltage of the node N4) obtained by rectifying the three-phase AC electric power using the diodes (32 to 34). The control unit 30 detects whether the rotor is rotating on the basis of the detection result from the rotation detecting unit 19.

Accordingly, with the battery charging device 1 according to the present embodiment, since whether the rotor is rotating is detected on the basis of the DC voltage (the voltage of the node N4) obtained by rectifying the three-phase AC electric power using the diodes (32 to 34), it is possible to appropriately detect whether the rotor is rotating with a simple configuration.

In the present embodiment, when stop of the rotor is detected, the control unit 30 switches the power supply sustaining switch 11 to the state in which supply of the control electric power of the switch elements (21 to 26) is stopped (for example, the OFF state).

Accordingly, with the battery charging device 1 according to the present embodiment, since the power supply sustaining switch 11 is switched to the state in which supply of the control electric power of the switch elements (21 to 26) is stopped (for example, the OFF state), it is possible to reduce power consumption while the device is stopped (on standby). That is, with the battery charging device 1 according to the present embodiment, it is possible to reduce a dark current.

The present invention is not limited to the aforementioned embodiment and can be modified without departing from the gist of the present invention.

For example, in the aforementioned embodiment, an example in which the switch elements (21 to 26) are N-channel MOS transistors has been described above, but the present invention is not limited thereto. The switch elements (21 to 26) may be other switch elements as long as they are switch elements including a parasitic diode (a body diode).

In the aforementioned embodiment, an example in which the ACG 2 outputs three-phase AC signals has been described above, but the present invention is not limited thereto. The ACG may output two-phase or less AC signals or four-phase or more AC signals.

In the aforementioned embodiment, an example in which the rectification unit 20 includes a rectification bridge and rectifies full waves of the AC signals has been described above, but the present invention is not limited thereto. Other rectification techniques may be employed.

The battery charging device 1 includes a computer system therein. The processes when the main switch 5 is switched to the turned-off state are stored in a computer-readable recording medium in the form of a program, and the processes are performed by causing a computer to read and execute the program. Here, the computer-readable recording medium is a magnetic disk, a magneto-optical disc, a CD-ROM, a DVD-ROM, or a semiconductor memory. This computer program may be transmitted to a computer via a communication line, and the computer having received the computer program may execute the computer program.

Some or all of the functions of the battery charging device 1 may be realized as an integrated circuit such as a large scale integration (LSI) circuit. The aforementioned functions may be individually formed as processors, or some or all thereof may be integrated as a processor.

The integration technology is not limited to LSI, and the functions may be realized by a dedicated circuit or a general-purpose processor. When integration technology replacing LSI appears with development of semiconductor technology, an integrated circuit based on the technology may be used.

### REFERENCE SIGNS LIST

1 Battery charging device
2 ACG
3 Battery
4 Load unit
5 Main switch
6 Fuse
7 Rotational position sensor
11 Power supply sustaining switch
12, 13, 18, 32, 33, 34 Diode
14 Power supply cutoff detecting unit
15 Internal power source generating unit
16 Sensor input buffer
19 Rotation detecting unit
20 Rectification unit
21, 22, 23, 24, 25, 26 Switch element
27 Capacitor
30 Control unit
31 FET driver unit

1. A battery charging device comprising:
a rectification unit configured to output DC electric power which is obtained by rectifying three-phase AC electric power output from a power generator as charging electric power of a battery through turning-on of a switch element connected to an output signal line of each phase of the three-phase AC electric power with rotation of a rotor;
a power supply sustaining switch that is able to be sustained in a state in which control electric power of the switch element from the battery is able to be supplied when a main switch for supplying the control electric power of the switch element from the battery to a power supply line is switched to a cutoff state in which supply of the control electric power to the power supply line is stopped; and
a control unit configured to control turning-on of the switch element, the control unit sustaining the power supply sustaining switch in a state in which the control electric power of the switch element is able to be supplied when the main switch is switched to the cutoff state and performing control such that the switch element on a negative electrode side connected to a negative electrode terminal of the battery is switched to a turned-on state when the rotor is rotating.

2. The battery charging device according to claim 1, wherein the switch element is a metal oxide semiconductor (MOS) transistor,
wherein the rectification unit includes a rectification bridge including a positive-electrode MOS transistor connected between a positive-electrode power supply line connected to a positive electrode terminal of the battery and the output signal line and a negative-electrode MOS transistor connected between a negative-electrode power supply line connected to a negative electrode terminal of the battery and the output signal line in each output signal line, and
wherein the control unit performs control such that the negative-electrode MOS transistor of the rectification bridge is switched to a turned-on state when the rotor is rotating.

3. The battery charging device according to claim 2, wherein the control unit alternately repeatedly performs a rotation detecting process of switching the positive-electrode MOS transistor and the negative-electrode MOS transistor to a turned-off state and detecting whether the rotor is rotating and a turning-on process of switching the negative-electrode MOS transistor to the turned-on state in a predetermined period.

4. The battery charging device according to claim 1, wherein the control unit detects whether the rotor is rotating on the basis of a voltage output from the power generator to the output signal line.

5. The battery charging device according to claim 4, further comprising a rotation detecting unit configured to detect whether the rotor is rotating on the basis of a DC voltage obtained by rectifying the three-phase AC electric power using a diode,
wherein the control unit detects whether the rotor is rotating on the basis of a detection result from the rotation detecting unit.

6. The battery charging device according to claim 1, wherein the control unit switches the power supply sustaining switch to a state in which supply of the control electric power of the switch element is stopped when stop of the rotor is detected.
